(19) United States
(12) Patent Application Publication
(10) Pub. No.: US 2002/0158465 A1
(43) Pub. Date: Oct. 31, 2002

(54) Breaking-type checking device for preventing false engagement

(75) Inventor: Kazuyuki Tsurumi, Koga-Shi (JP)

Correspondence Address: LADAS & PARRY, 26 West 61st Street, New York, NY, 10023, US

(73) Assignee: SANOH KOGYO KABUSHIKI KAISHA

(21) Appl. No.: 10/127,293

(22) Filed: Apr. 22, 2002

(30) Foreign Application Priority Data
Apr. 27, 2001 (JP) 2001-131616

(51) Int. Cl. F16L 35/00

(52) U.S. Cl. 285/93; 285/319

(57) ABSTRACT

A checking device 60 includes a C-shaped member 61 seated on the end face 33 of a retainer 30, a ring member 62 inserted into the retainer 30 and a pair of connecting members 63 connecting the C-shaped member 61 and the ring member 62. Each of the connecting members 63 has a weak portion 64, such as a V-notch. After the spool 42 has advanced beyond the pawls 32, the weak portion 64 is broken by a second-tube-inserting force exerted on the connecting members 63 via the spool 42 and the ring member 62 on which the spool 42 is seated.

### BACKGROUND OF THE INVENTION

1. Field of the Invention

The present invention relates to a checking device for preventing a false engagement between pawls of a retainer and a spool of a pipe, when, for example, a connection of fuel pipes, air tubes, or the like is to be established.

2. Description of the Related Art

In general, since fuel pipes, air tubes, and the like of a vehicle are laid out among many pieces of equipment, quick, one-touch connectors are used to facilitate the connection thereof. This type of connector comprises a connector housing to be connected to a first pipe and a retainer to be engaged with the connector housing. The retainer has pawls to be engaged with a spool formed on a second pipe. In such a joint structure, if the engagement between the spool and the pawls is imperfect, this might cause liquid to leak at a later date and might thereby be the case of an accident. In actual situations, however, the determination as to whether the engagement between the spool and the pawls has been perfectly achieved, solely relies upon the discretion of a person performing assembly.

In light of such situations, in order to enhance the reliability of the joint, some devices for checking whether the connection is reliably established, have been proposed. An example of such a device is disclosed in Japanese Examined Utility Model publication No. Hei06-29590, the assignee of which is the same as that of this application.

The operation of the above device is as follows. A pair of shutters, each of which is provided with a spring, are arranged in a connector housing. The shutters close a tube-insertion opening of the connector housing by the spring action. A checking member is inserted into the connector housing to engage with the shutters, whereby the checking member forces the shutter to open against the closing force of the springs. When a predetermined length of the tube is inserted into the tube-insertion opening, a spool formed on the tube further forces the shutter to open. Thereupon, the engagement of the checking member with the shutters is released. The establishment of reliable connection is confirmed by the fact that the checking member can be pulled out from the connector housing. Insofar as the solving of the above-described problem is concerned, this device would be satisfactory.

However, this conventional structure needs to be designed specifically for the connector housing to insert the checking member. It is difficult, therefore, to apply this device to standard type of quick connectors (e.g., the connector type shown in the embodiment).

### SUMMARY OF THE INVENTION

Accordingly, it is an object of the present invention to solve the above-described problem and to provide a checking device capable of checking the engagement condition between the retainer and the pipe with ease and reliability, without the need for a specific design for the connector housing and the retainer.

In order to achieve the objective, the present invention provides a checking device for preventing a false engagement between a pawl and a spool when assembling a pipe joint structure, which includes a connector housing to which a first tube is connected, a retainer secured to the connector housing and having the pawl, and a second tube provided with the spool retained by the pawl. The checking device includes: a first member configured to be seated on the retainer at a position behind the pawl with respect to an inserting-direction of the second tube; a second member capable of being inserted into the retainer, the second member being configured so that the spool is seated thereon; and connecting members connecting the first and the second members, each of the connecting members having a weak portion and being configured such that, after the spool has advanced beyond the pawl, the weak portion is broken by a force exerted on the connecting member through the spool and the second member upon insertion of the second tube.

According to the present invention, the connecting members are not broken until the spool of the second pipe is inserted up to a predetermined position, that is, the position where a reliable engagement between the spool and the pawls of the retainer is ensured, so that the engagement between the pawls of the retainer and the spool of the second pipe can be confirmed with ease and reliability.

The above and other objectives, features, and advantages of the present invention will be apparent from the following detailed description of the preferred embodiments of the invention in conjunction with the accompanying drawings.

### BRIEF DESCRIPTION OF THE DRAWINGS

FIG. 1 is a cross-sectional view showing a joint structure when the checking device according to the present invention is not used;

FIG. 2 is a cross-sectional view showing a possible false engagement, which causes a problem when the checking device according to the present invention is not used;

FIG. 3 is a perspective view showing the checking device according to the present invention; and

FIGS. 4A to 4C are cross-sectional views showing the utilization of the checking device according to the present invention.

### DESCRIPTION OF THE PREFERRED EMBODIMENTS

Prior to describing the embodiment of the present invention, a reference will be made to a joint structure to which the checking device according to the present invention is applied. FIG. 1 is a partial sectional view showing a joint structure when the checking device according to the present invention is not installed.

The joint structure includes: a connector housing 20 to which a flexible tube 10 (i.e., a first tube) is connected; a retainer 30 mounted to the housing 20; and a pipe 40 (i.e., a second tube) inserted into the retainer 30 to be held in position by the retainer 30. Assembly of the housing 20 and the retainer 30 is achieved by engaging their respective pawls 21 and 31 with each other.

The retainer 30 has a pair of locking pawls 32 formed at symmetrical positions about the center axis A. The front end of each of the locking pawls 32 is elastically displaceable substantially in the radial directions of the pipe 40 (i.e., the directions substantially perpendicular to the center axis A). The pipe 40 has a spool 42, which is an annular projection formed on the outer surface of the pipe 40. The spool 42 is retained by the locking pawls 32, and the pipe 40 is thus secured to the retainer 30.

A step portion 22 is formed on the inner surface of the housing 20. When the retainer 30 is mounted to the housing 20, a circumferential groove is formed between the step portion 22 and the front end of the retainer 30. An O-ring 50 is arranged in the circumferential groove.

Next, the assembly of this joint structure will be described. First, the O-ring 50 is placed in the vicinity of the step portion 22 of the housing 20, and then the retainer 30 is coupled to the housing 20. Thereafter, the pipe 40 is inserted into the retainer 30 from the right side in FIG. 1. As the pipe 40 advances, the spool 42 of the pipe 40 moves the locking pawls 32 in radial directions so that they spread apart from each other, and the spool 42 is finally passed through the locking pawls 32. After the spool 42 has passed through the locking pawls 32, the locking pawls 32 return to their original positions (the positions shown in FIG. 1), preventing the pipe 40 from moving out of the retainer 30.

At this time, the outer surface of the front end portion of the pipe 40 is in close contact with the inner peripheral surface of the O-ring 50, and simultaneously presses the outer peripheral surface of the O-ring 50 against the inner surface of the housing 20. Thereupon, the tube 10 and the pipe 40 are connected with each other in liquid-tight manner via the housing 20 and the retainer 30. The size and shape of each of the component members constituting this joint structure is such that the proper engagement between the O-ring 50 and the pipe 40 can be established as long as the spool 42 has been advanced beyond the locking pawls 32.

When the pipe 40 is removed from the retainer 30, grips 35 are pinched inward in the radial directions so that the locking pawls 32 spread apart from each other, allowing the pipe 40 to be removed from the retainer 30.

Since the above-described structure and the assembly described with reference to FIG. 1 is well known to those in the art, further detailed explanations are omitted.

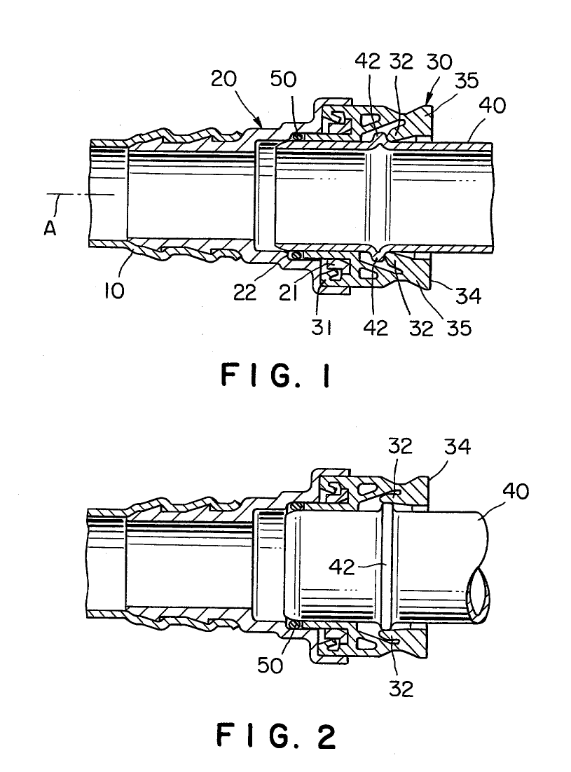

Next, the problem, having been briefly referred to in “Description of the Related Art”, associated with the joint structure shown in FIG. 1 will be described. With the type of the joint structure shown in FIG. 1, the determination as to whether the pipe 40 has been securely inserted relies upon the discretion of the person performing the assembly. This “discretion” specifically refers to: the perception of sounds occurring at the moment when the spool 42 has passed the locking pawls 32; and the perception of an increase of the insertion force of the pipe 40 caused by the insertion of the front end portion the pipe 40 into the O-ring 50. Therefore, in the event that assembly is performed in a noisy environment, even if the spool 42 has not passed the locking pawls 32 as shown in FIG. 2, since the insertion force of the pipe 40 will increase when the front end portion of the pipe 40 begins to enter into the O-ring 50, the person performing assembly might have an illusion that he or she has completed the insertion of the pipe 40. Needless to say, use of this joint structure in this state would result in a high possibility that the pipe 40 could slip out of the retainer 30 due to the vibrations acting on the joint structure and/or the increase in the pressure of the fluid passing through the joint structure (e.g., when the vehicle is being operated). This is the potential problem involved in the conventional art.

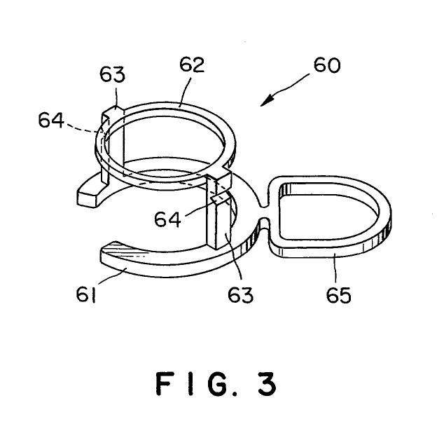

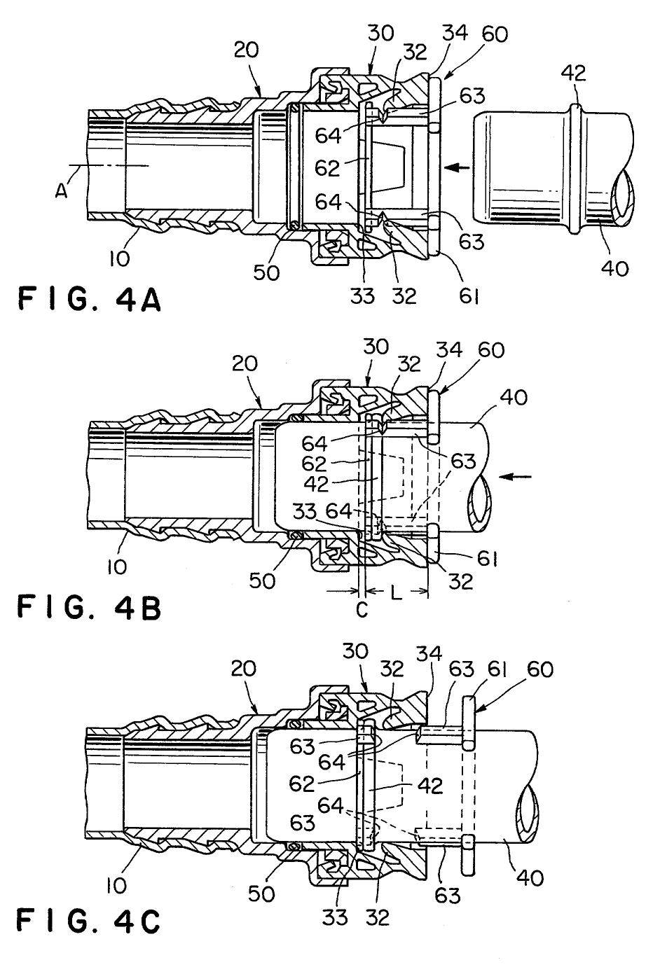

Here, a checking device 60 according to the present invention capable of solving the above-described problem without the need for specific designs of the housing, retainer, and the like, will be described with reference to FIG. 3 and FIGS. 4A to 4C. As is evident from FIGS. 4A to 4C, the component members shown in FIGS. 4A to 4C are the same as those in FIG. 1 except for the checking device 60. These same members, therefore, are denoted by the same reference numerals as in FIG. 1, and repeated descriptions are omitted.

The checking device 60 comprises a C-shaped member 61, a ring member 62, and a pair of connecting members 63 each connecting the C-shaped member 61 and the ring member 62. The C-shaped member 61 has an annular shape which is partially cut off.

The C-shaped member 61 is of such a size as to be seated on the end face 34 of the retainer 30. The inner diameter of the C-shaped member 61 is of such a size that the spool 42 of the pipe 40 can pass through the C-shaped member 61.

The inner diameter of the ring member 62 is such a size that the spool 42 of the pipe 40 cannot pass through the ring member 62, but that the front end portion of the pipe 40 past the spool 42 can pass through the ring member 62. The outer diameter of the ring member 62 is substantially the same as that of an annular seat 33 formed in the retainer 30, thus the ring member 62 cannot advance beyond the seat 33.

Each of the connecting members 63 extend in parallel with the center axis A. A V-shaped notch 64, namely a weak portion, is formed in each of the connecting members 63.

The connecting members 63 are disposed at symmetrical positions with respect to the center axis A. The connecting members 63 are respectively arranged at the positions deviating by about 45 degrees in the circumferential direction (i.e., in the direction of the circumference about the center axis A) from the positions where the locking pawls 32 are located, in order to prevent the connecting members 63 from colliding against the locking pawls 32 of the retainer 30 when the checking device 60 is inserted into the retainer 30.

The checking device 60 can be easily integrally-molded by a resin injection molding method or the like.

Next, a description will be made of the utilization of the checking device 60. As shown in FIG. 4A, firstly, the housing 20, in which the O-ring 50 is placed at a predetermined position, is coupled to the retainer 30. Then, the checking device 60 is inserted into the retainer 30, and the C-shaped member 61 of the checking device 60 is seated on the end surface 34 of the retainer 30. At this time, the ring member 62 is advanced to a predetermined distance beyond the locking pawls 32.

Then, the pipe 40 is inserted into the retainer 30 through the C-shaped member 61 and the ring member 62 of the checking device 60. As shown in FIG. 4B, when the pipe 40 is inserted a predetermined distance into the retainer 30, the spool 42 of the pipe 40 is seated on the ring member 62 of the checking device 60. At this time, the spool 42 has already passed the locking pawls 32 of the retainer 30, and the front end portion of the pipe 40 has been properly engaged with the O-ring 50.

In this state, as shown in FIG. 4B, there exists a clearance C between the ring member 62 of the checking device 60 and the seat 33 within the retainer 30. When the pipe 40 is further inserted into the retainer 30, since the C-shaped member 61 of the checking device 60 is not able to move forward in the direction of the center axis A, the connecting members 63 are subjected to a tensile force. This tensile force causes breakage of the connecting members 63 starting from the notch 64. Thereby, the checking device 60 is separated into two portions, one portion on the C-shaped member 61 side and the other portion on the ring member 62 side.

The portion of the checking device 60 on the C-shaped member 61 side can be easily drawn out of the retainer 30. In addition, as the C-shaped member 61 has an annular shape which is partly cut off, the portion on the C-shaped member 61 side thus separated can be easily removed from the pipe 40 by passing the pipe 40 through the cut-off portion of the C-shaped member 61. The portion of the checking device 60 on the ring member 62 side remains within the retainer 30, but the remaining portion has no adverse effect on the function of the joint structure. This is because, the remaining portion is one piece, will never break up, and is held in position by the pipe 40 and the retainer.

In order to facilitate the removal of the portion of the checking device 60 on the C-shaped member 61 side, the checking device 60 has a pull-tab 65 (see FIG. 3). An appropriate engagement between the spool 42 of the pipe 40 and the locking pawls 32 of the retainer 30 is confirmed by the fact that the portion on the C-shaped member 61 side can be easily removed without any resistance by pulling the pull tab 65. It is undesirable, therefore, that the connecting portion between the pull-tab 65 and the C-shaped member 61 be so rigid that the connecting members 63 are broken when the pull-tab 65 is pulled.

As is evident from the foregoing, the distance L (see FIG. 4B) between the C-shaped member 61 and the ring member 62 is such that the connecting members 63 never break before the spool 42 has completely passed the locking pawls 32. In other words, the distance L is such that the connecting members 63 never break before the spool 42 has reached the position as shown in FIG. 4B.

Preferably, the distance L is such that the spool 42 just begins to contact the ring member 61 when the spool 42 of the pipe 40 has just passed the locking pawls 32 of the retainer 30, and that the connecting members 63 break as the pipe 40 is further inserted to the point where the ring member 62 pass through the area corresponding to the clearance C.

While the present invention has been described with reference to what are at present considered to be the preferred embodiments, it is to be understood that various changes and modifications may be made thereto without departing from the invention in its broader aspects and therefore, it is intended that the appended claims cover all such changes and modifications that fall within the true spirit and scope of the invention.

What is claimed is:

1. A checking device for preventing a false engagement between a pawl and a spool when assembling a joint structure, the joint structure including a connector housing to which a first tube is connected, a retainer secured to the connector housing and having the pawl, and a second tube provided with the spool retained by the pawl, said checking device comprising:
a first member configured to be seated on the retainer at a position behind the pawl with respect to an inserting-direction of the second tube;
a second member capable of being inserted into the retainer, the second member being configured so that the spool is seated thereon; and
connecting members connecting the first and the second members, each of the connecting members having a weak portion and being configured such that, after the spool has advanced beyond the pawl, the weak portion is broken by a force exerted on the connecting member through the spool and the second member upon insertion of the second tube.

2. The checking device according to claim 1, wherein the first member is a C-shaped member having a cut-off portion allowing the second tube to pass through the cut-off portion.

3. The checking device according to claim 1, wherein the weak portion is a notch.

4. The checking device according to claim 1, wherein a pull-tab is connected to the first member.
